(19) United States
(12) Patent Application Publication
(10) Pub. No.: US 2010/0238487 A1
(43) Pub. Date: Sep. 23, 2010

(54) Print system

(75) Inventor: Makoto Sekiya, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka-Shi (JP)

(21) Appl. No.: 12/661,596

(22) Filed: Mar. 16, 2010

(30) Foreign Application Priority Data
Mar. 19, 2009 (JP) 2009-068152

(51) Int. Cl. G06F 3/12

(52) U.S. Cl. 358/1.15

(57) ABSTRACT

A print system according to one embodiment of the present invention includes a terminal apparatus, a print server, and a printing apparatus connected to each other via a network. The terminal apparatus includes a transmission unit for transmitting a print job of a user to the print server as a print job addressed to another user. The print server includes a storage unit for storing the print job of the user that has been transmitted from the terminal apparatus, as a print job addressed to the other user, and a transfer unit for transferring the print job addressed to the other user to the printing apparatus in response to a request from the printing apparatus. The printing apparatus includes a transfer request unit for requesting the print server to transfer the print job addressed to the other user stored in the print server.

This application claims priority under 35 U.S.C. §119(a) on Patent Application No. 2009-068152 filed in Japan on Mar. 19, 2009, the entire contents of which are herein incorporated by reference.

### BACKGROUND OF THE INVENTION

1. Field of the Invention

The present invention relates to a print system in which a terminal apparatus, a print server, and a printing apparatus are connected to each other via a network.

2. Description of Related Art

A conventional system of this type is disclosed in JP 2007-334918A. In the system disclosed in JP2007-334918A, a plurality of terminal apparatuses (personal computers), a plurality of print servers, a plurality of multi-function peripherals, and a printing management server are connected to each other via a network, and a print job is transmitted from a terminal apparatus to the print server, and temporarily stored therein. A user, by designating a print job from a desired multi-function peripheral, transfers this print job from the print server to that multi-function peripheral, and executes this print job on that multi-function peripheral. A print job can thereby be executed on a desired multi-function peripheral.

However, in the conventional system, folders of a plurality of users are set in the print server, and each user transmits his or her print job from the terminal apparatus to his or her own folder in the print server so as to store the print job therein, and by designating the print job in his or her own folder in the print server from the multi-function peripheral, transfers this print job from the print server to that multi-function peripheral, and executes the print job on the multi-function peripheral.

Therefore, the user is only able to designate a print job stored in his or her own folder. Accordingly, other users are unable to transfer that print job to a desired multi-function peripheral, or execute the print job on that multi-function peripheral.

### SUMMARY OF THE INVENTION

In view of the above, the present invention has been conceived to solve the above problems, and has as its object to provide a print system in which a print job can be distributed from a user to other users via a print server, so that even other users can execute that print job on a desired multi-function peripheral.

In order to solve the above problems, the present invention provides a print system in which a terminal apparatus, a print server, and a printing apparatus are connected to each other via a network. The terminal apparatus includes a transmission unit for transmitting a print job of a user to the print server as a print job addressed to another user. The print server includes a storage unit for storing the print job of the user that has been transmitted from the terminal apparatus, as a print job addressed to the other user, and a transfer unit for transferring the print job addressed to the other user stored by the storage unit to the printing apparatus in response to a request from the printing apparatus. The printing apparatus includes a transfer request unit for requesting the print server to transfer the print job addressed to the other user, by designating the print job addressed to the other user stored in the print server.

According to this configuration, another user can transfer the print job addressed to himself or herself from the print server to a printing apparatus, and execute this print job on that printing apparatus. Specifically, a print job of a user can be distributed, via the print server, from a terminal apparatus to a printing apparatus selected by another user, and this print job can be executed on that printing apparatus.

Further, in the present invention, the storage unit may store, in a folder of the other user, the print job addressed to the other user that has been transmitted from the terminal apparatus, and the transfer unit may transfer the print job stored in the folder of the other user to the printing apparatus.

With this configuration, another user can, by designating the print job in his or her folder stored in the print server from a desired printing apparatus, transfer this print job from the print server to that printing apparatus, and execute the print job on that printing apparatus.

Further, in the present invention, the terminal apparatus may include a folder display unit for displaying folders of a plurality of other users set in the print server, and a folder selection unit operated in order to select any of the folders of the other users displayed by the folder display unit. The storage unit may store the print job of the user in the folder of another user selected by the folder selection unit being operated.

With this configuration, even if folders of a plurality of other users are set in the print server, it is possible to easily select another desired user, and store a print job in the folder of this other user, thereby improving operability.

Further, in the present invention, the print server may include an e-mail transmission unit for, when the print job of the user is stored by the storage unit as a print job addressed to another user, creating and transmitting an e-mail addressed to the other user notifying that the print job is stored.

With this configuration, another user can, by checking that e-mail on his or her terminal apparatus, be informed that the print job has been transmitted to the print server.

Further, in the present invention, the printing apparatus may include a print job display unit for displaying a print job stored in the print server, and a print job selection unit operated in order to select a print job displayed by the print job display unit. The transfer request unit may request the print server to transfer the print job selected by the print job selection unit being operated.

With this configuration, it is possible, by selecting a desired print job, to transfer the selected print job to the printing apparatus, and execute the desired print job, thereby improving operability.

Further, in the present invention, the printing apparatus may include an external memory storage unit for storing the print job transferred from the print server in an external portable memory that is removably connected to the printing apparatus.

With this configuration, instead of immediately executing the print job on the printing apparatus, another user can store the print job in the external portable memory. In this case, the print job can be transferred from the external portable memory to the terminal apparatus of the other user, stored therein, and displayed on the display screen of the terminal apparatus.

### BRIEF DESCRIPTION OF THE DRAWINGS

FIG. 1 is a block diagram showing an embodiment of a print system according to the present invention.

FIG. 2A is a block diagram showing the configuration of a terminal apparatus in the print system shown in FIG. 1.

FIG. 2B is a block diagram showing the configuration of a print server in the print system shown in FIG. 1.

FIG. 3 is a block diagram showing the configuration of a multi-function peripheral in the print system shown in FIG. 1.

FIG. 4 illustrates a print distribution destination setting screen displayed on the terminal apparatus in the print system shown in FIG. 1.

FIG. 5 conceptually shows folders of a plurality of users set in the print server in the print system shown in FIG. 1.

FIG. 6 illustrates an authentication data input screen displayed on the terminal apparatus in the print system shown in FIG. 1.

FIG. 7 illustrates a list screen for print jobs displayed on the terminal apparatus in the print system shown in FIG. 1.

FIG. 8 illustrates an e-mail including a message indicating that other users have received the print job, in the print system shown in FIG. 1.

FIG. 9 is a flowchart showing a processing procedure performed by the terminal apparatus in the print system shown in FIG. 1.

FIG. 10 is a flowchart showing a processing procedure performed by the print server in the print system shown in FIG. 1.

FIG. 11 is a flowchart showing a processing procedure for pull printing performed by the multi-function peripheral in the print system shown in FIG. 1.

### DESCRIPTION OF PREFERRED EMBODIMENTS

Hereinafter, an embodiment of the present invention will be described in detail with reference to the accompanying drawings.

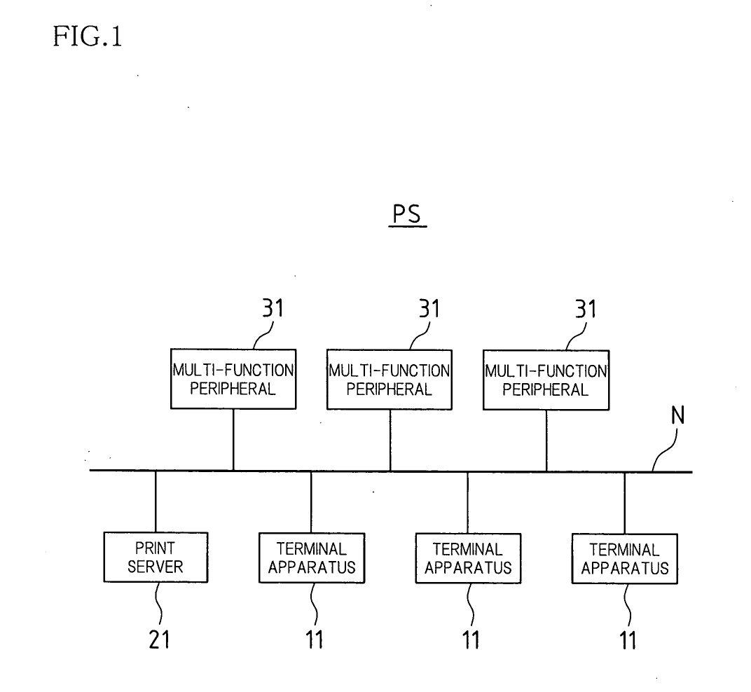

FIG. 1 is a block diagram showing an embodiment of a print system according to the present invention. In a print system PS according to the present embodiment, a plurality of terminal apparatuses (personal computers) 11, a print server 21, and a plurality of multi-function peripherals 31 (printing apparatuses in the present invention) are connected to each other via a network N, so that a print job or the like can be transmitted to and received by any of the terminal apparatuses 11, the print server 21, and the multi-function peripherals 31. Although it is assumed that the network N is a LAN, the Internet, or the like, another type of a network may be applied.

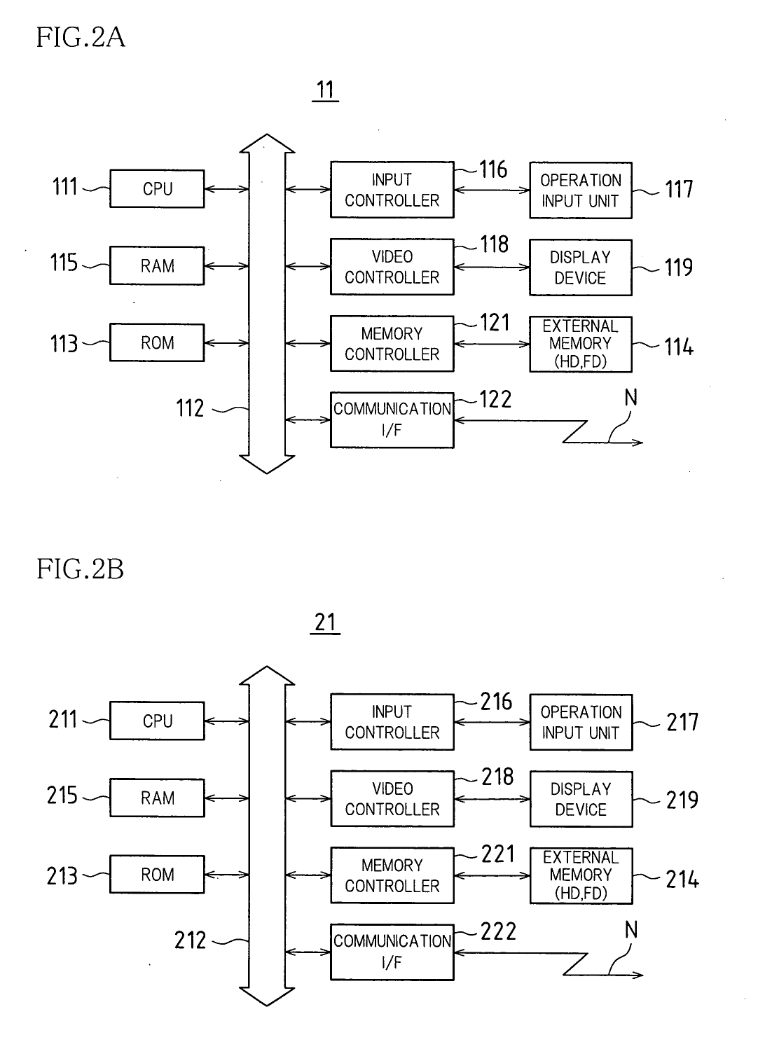

FIGS. 2A and 2B are block diagrams showing the configurations of the terminal apparatuses 11 and the print server 21. Note that in FIGS. 2A and 2B, since the terminal apparatuses 11 and the print server 21 basically have the same configuration, the portions that similarly function are given the same names, and only the reference numerals thereof are changed.

In FIGS. 2A and 2B, CPUs 111 and 211 control the devices and the like via system buses 112 and 212, and perform overall control of the terminal apparatus 11 and the print server 21. ROMs 113 and 213 and external memories 114 and 214 have stored therein a BIOS (Basic Input/Output System), an operating system (OS), and various programs or the like necessary to realize the functions of the terminal apparatus 11 and the print server 21, which are executed by the CPUs 111 and 211.

RAMs 115 and 215 function as main memories and work areas of the CPUs 111 and 211, for instance. The CPUs 111 and 211 load necessary programs and the like from the ROMs 113 and 213 and the external memories 114 and 214 into the RAMs 115 and 215, and execute the programs, thus realizing the functions of the terminal apparatus 11 and the print server 21.

Input controllers 116 and 216 relay input from operation input units 117 and 217, such as a keyboard and a mouse, to the CPUs 111 and 211.

Video controllers 118 and 218 perform display control of display devices 119 and 219. The CPUs 111 and 211 rasterize texts, images, and the like in display memory areas in the RAMs 115 and 215, or the like. The video controllers 118 and 218 display the rasterized texts, images, and the like on the screens of the display devices 119 and 219. Further, the CPUs 111 and 211 move cursors on the screens of the display devices 119 and 219 according to the input from the operation input units 117 and 217, which enables instructions with the cursors. Note that any type of device, such as a liquid crystal display, a CRT, or an EL display, may be used for the display devices.

Memory controllers 121 and 221 control reading and writing with respect to the external memories 114 and 214. The external memories 114 and 214 include portable memories, such as a hard disk (HD), a flexible disk (FD), or a CompactFlash (registered trademark), and the memory controllers 121 and 221 execute reading and writing with respect thereto.

Communication interfaces (communication I/Fs) 122 and 222 perform data communication between the terminal apparatuses 11, the print server 21, and the multi-function peripherals 31 via the network N, and execute communication control of such data communication. For example, the communication I/Fs 122 and 222 perform communication control using TCP/IP.

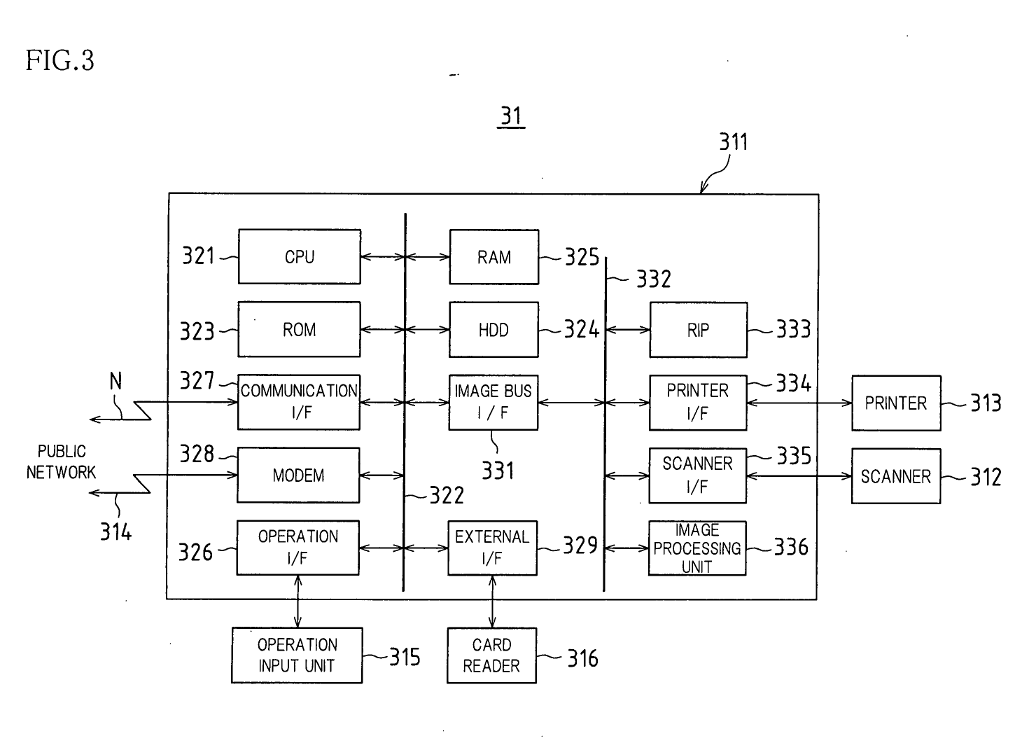

FIG. 3 is a block diagram showing the configuration of the multi-function peripherals 31. In FIG. 3, an image control unit 311 controls a scanner 312 that reads original images, and a printer 313 that prints texts, images, and the like on recording paper, and also transmits and receives print jobs and the like via the network N and a public network 314 (a PSTN, an ISDN, or the like).

In the image control unit 311, a CPU 321 controls devices and the like via a system bus 322, and performs overall control of the multi-function peripheral 31. A ROM 323 has stored therein a boot program, and various control programs. A hard disk drive (HDD) 324 has stored therein various application programs, image data, and the like.

A RAM 325 functions as a main memory, a work area, and the like of the CPU 321, for instance. The CPU 321 loads necessary programs and the like from the ROM 323 and the HDD 324 into the RAM 325, and executes the programs so as to control the multi-function peripheral 31.

An operation interface (operation I/F) 326 is an interface with an operation input unit 315, and outputs an image to the operation input unit 315 so as to display this image on the screen of a display device attached to the operation input unit 315. Further, When a instruction is given through a touch panel superimposed on the screen of the display device, the operation I/F 326 determines the input given with respect to buttons, keys, and the like, displayed on the screen of the display device. The buttons and keys include a start key, a stop key, an ID key, and a reset key. The start key is operated when giving an instruction to start reading an original image with the scanner 312. The stop key is operated when giving an instruction to stop operation of the scanner 312 and the printer 313. The ID key is operated when inputting a user name and a password. The reset key is used when initializing settings configured by the operation input unit 315. Note that any type of device, such as a liquid crystal display, a CRT, or an EL display, may be used for the display device.

A communication interface (communication I/F) 327 performs data communication with the terminal apparatus 11 or the print server 21 via the network N, and executes communication control of such data communication. A modem 328 is connected to the public network 314, and performs facsimile communication and the like with a communication terminal of the user with which communication is being performed, via the public network 314.

An external interface (external I/F) 329 is an interface that receives external inputs, such as a USB interface, an IEEE1394 interface, a printer port, or an RS-232C interface. A card reader 316 for reading an IC card is connected to the external I/F 329. The CPU 321 inputs and obtains authentication data read by the card reader 316 from an IC card via the external I/F 329. Further, other than the card reader, a reader/writer, a connector, and the like (not shown) to which an external portable memory (for example, a USB memory) can be removably connected are connected to the external I/F 329.

The card reader 316 is controlled by the CPU 321, reads authentication data from an IC card (for example, Sony Felica (registered trademark)), and notifies the CPU 321 of this authentication data via the external I/F 329.

An image bus interface (image bus I/F) 331 is a bus bridge that interconnects the system bus 322 and an image bus 332 for transferring image data, and interconverts data structures between both buses.

The image bus 332 is constituted by a PCI bus or an IEEE1394 bus. A raster image processor (RIP) 333, a printer interface (printer I/F) 334, a scanner interface (scanner I/F) 335, and an image processing unit 336 are connected to this image bus 332.

The RIP 333 develops vector data using PDL code or the like, for example, into a bitmap image.

The printer I/F 334 connects the printer 313 to the image control unit 311, and performs synchronous/asynchronous conversion of image data. If an instruction to start printing is given by the operation input unit 315 being operated, the printer 313 is started by the CPU 321. The printer 313 records an image (raster image) on recording paper, and may be any of an electrophotographic printer that forms a toner image on a photosensitive body, and transfers this formed toner image to recording paper, an inkjet printer that ejects ink directly onto recording paper, or the like. Moreover, the printer 313 is provided with a plurality of paper feed trays in order to enable selection between different paper sizes and different paper orientations.

Further, the scanner I/F 335 connects the scanner 312 to the image control unit 311, and performs synchronous/asynchronous conversion of image data. If an instruction to start scanning is given by the operation input unit 315 being operated, the scanner 312 is started by the CPU 321. If the scanner 312 is started, original paper is pulled out from the tray, an original image is read by a CCD line sensor, and image data that indicates this original image (raster image) is generated and outputted.

The image processing unit 336 corrects, processes, and edits image data. For example, the image processing unit 336 performs correction, resolution conversion, and the like according to the characteristics of the multi-function peripheral 31. Alternatively, the image processing unit 336 performs image rotation, JPEG compression/decompression conversion processing on multi-value image data, and compression/decompression conversion processing using JBIG, MMR, MH, or the like on binary image data.

In the print system PS that has such a configuration, the terminal apparatus 11 can generate and transmit a print job that is composed of image data and a print processing command, by executing a printer driver. The printer driver receives image data from an application program, for example, and generates a print job, or reads out a print job from a storage device, and transmits this print job to the print server 21 via the network N.

This print job is immediately transmitted from the print server 21 to the multi-function peripheral 31 so as to be executed, or temporarily kept in the print server 21. If the print job is temporarily kept in the print server 21, a user, by designating the print job from a desired multi-function peripheral 31, transfers this print job from the print server 21 to the multi-function peripheral 31, and executes this print job on the multi-function peripheral 31.

Therefore, in the print system PS, it is possible to immediately transmit a print job from the terminal apparatus 11 to a desired multi-function peripheral 31 via the print server 21, and execute the print job on the multi-function peripheral 31 (referred to as normal printing). Further, it is possible to transmit a print job from the terminal apparatus 11 to the print server 21, temporarily keep the print job in the print server 21, and thereafter designate and read out the print job in the print server 21 from the multi-function peripheral 31 (referred to as pull printing).

Conventionally, when performing pull printing, it has only been possible for the print job of a user to be transmitted to and stored in the folder of that user in the print server 21, but it has not been possible for the print job of a user to be transmitted to and stored in the folder of another user.

In view of this, in the print system PS according to the present embodiment, it is possible to transmit the user's print job to another user's folder in the print server 21, and store the print job therein. Specifically, a print job can be distributed to other users from the user via the print server 21, so that even other users can execute this print job by performing pull printing.

Next, a detailed description is given regarding normal printing and pull printing in the print system PS according to the present embodiment.

First, in the case of normal printing in which a print job is immediately transferred from the print server 21 to the multi-function peripheral 31, the terminal apparatus 11 shown in FIG. 2A, by executing the printer driver using the CPU 111, generates a print job in the RAM 115, or reads out a print job from the external memory 114 via the memory controller 121, and transmits this read print job from the communication I/F 122 to the print server 21 via the network N.

In the print server 21 shown in FIG. 2B, the print job from the terminal apparatus 11 is received by the communication I/F 222, stored in the external memory 214 via the memory controller 221, and immediately transmitted from the communication I/F 222 to the multi-function peripheral 31.

In the multi-function peripheral 31 shown in FIG. 3, the print job from the print server 21 is received by the communication I/F 327, and temporarily stored in the HDD 324 or the like. This print job is read out from the HDD 324 or the like, and delivered to the image processing unit 336 via the image bus I/F. After the image processing unit 336 performs image processing on the image data of the print job, the result is delivered via the printer I/F 334 to the printer 313. The printer 313 analyzes this print job, and records an image (raster image) indicated by the image data of this print job on recording paper.

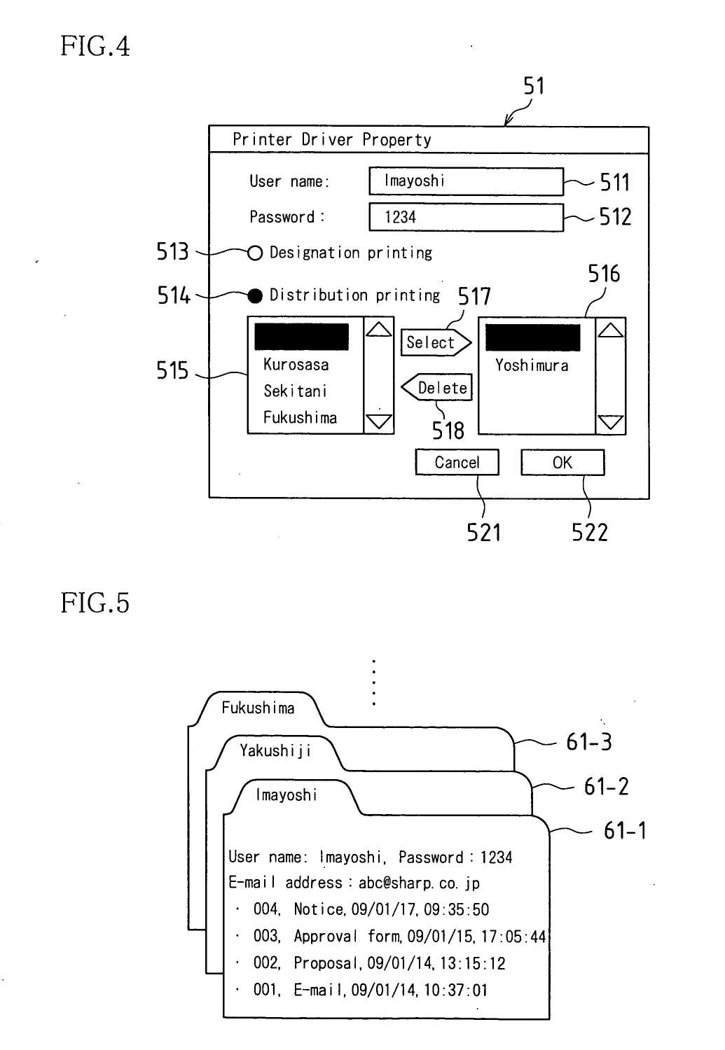

Next, in the case of pull printing in which a print job is temporarily kept in the print server 21, and thereafter the kept print job is designated from the multi-function peripheral 31 and read out, the terminal apparatus 11 shown in FIG. 2A generates a print job similarly to normal printing, but displays a print distribution destination setting screen 51 as shown in FIG. 4 on the display device 119, before transmitting this print job to the print server 21. Specifically, before transmitting the print job to the print server 21, the CPU 111 gives an instruction to the video controller to display the print distribution destination setting screen 51 on the display device 119. That is, in the present embodiment, a folder display unit in the present invention is realized by the CPU 111, the video controller 118, and the display device 119.

On the print distribution destination setting screen 51 shown in FIG. 4, fields 511 and 512 for entering a name and password of a user of the terminal apparatus 11, check fields 513 and 514 for instructing selection of designation printing according to which a print job is stored in the user's own folder, or distribution printing according to which a print job is stored in a folder of another user, an introduction field 515 in which other user names are displayed, a selection field 516 in which other user names selected as distribution destinations are displayed, a selection button 517 for selecting a user name from other user names in the introduction field 515 (that is, folders of a plurality of other users set in the print server 21), and putting the user name in the selection field 516, a deletion button 518 for deleting other user names in the selection field 516, a cancel button 521, and an OK button 522 are set and displayed. The user names were sent from the print server 21 in response to an inquiry from the terminal apparatus 11, and stored in the terminal apparatus 11. Thus, in the present embodiment, a folder selection unit in the present invention is realized by the display device 119 and the operation input unit 117.

With the terminal apparatus 11 shown in FIG. 2A, a user, by operating the operation input unit 117, makes entries to the fields in the print distribution destination setting screen 51 displayed on the display device 119, and operates the OK button 522 after having finished making entries. In response to this, the CPU 111 generates distribution destination identification information based on the entered contents of the fields on the print distribution destination setting screen 51, adds this distribution destination identification information to the print job, and then transmits this print job to the print server 21.

For example, suppose that in the print distribution destination setting screen 51, the name and password of the user of the terminal apparatus 11 are entered in the fields 511 and 512, the check field 513 for designation printing according to which a print job is stored in the user's own folder is turned on, and thereafter the OK button 522 is operated. In this case, the CPU 111 generates distribution destination identification information that indicates a user name and a password, and that the user's own folder is designated as the storage destination of the print job, adds this distribution destination identification information to the print job, and transmits this print job from the communication I/F 122 to the print server 21 via the network N.

In the print server 21 shown in FIG. 2B, the print job from the terminal apparatus 11 is received by the communication I/F 222, and is temporarily stored in the RAM 215 or the like, and the distribution destination identification information of the print job is analyzed by the CPU 211. The CPU 211 analyzes the distribution destination identification information, searches for the user's own folder, which is the storage destination of the print job, based on the analysis result, and stores the print job in the user's own folder in the external memory 214.

As shown in FIG. 5, in the external memory 214, a plurality of users' folders 61-1, 61-2, 61-3, . . . are set, and a name, a password, and an e-mail address of each user are registered in these folders. Accordingly, if distribution destination identification information is analyzed so as to obtain a user name and a password, and a folder in which the name and the password of this user are registered is searched for, this folder can be obtained as the user's own folder. For example, if the user's own folder is the folder 61-1, the print job is stored in the folder 61-1.

After this, the user goes to a desired multi-function peripheral 31, and causes the card reader of the multi-function peripheral 31 to read his or her own IC card. This authentication data is transmitted from the multi-function peripheral 31 to the print server 21, verified with authentication data registered in the print server 21, and authenticated. If an authentication reply is received from the print server 21, the multi-function peripheral 31, by designating the print job in the folder in the print server 21, transfers this print job from the print server 21 to the multi-function peripheral 31, and performs print processing on image data of the print job by executing this print job. Accordingly, the user can execute a print job on a desired multi-function peripheral 31.

On the other hand, suppose that on the print distribution destination setting screen 51, the name and password of the user of the terminal apparatus 11 are entered in the fields 511 and 512, the check field 514 for distribution printing according to which a print job is stored in another user's folder is turned on, another user's name is displayed in the selection field 516, and thereafter the OK button 522 is operated. In this case, the CPU 111 generates distribution destination identification information that indicates a user name, a password, the other user's name, and the other user's folder as the storage destination of the print job, adds this distribution destination identification information to the print job, and transmits this print job from the communication I/F 122 to the print server 21 via the network N. Thus, in the present embodiment, a transmission unit in the present invention is realized by the CPU 111 and the communication I/F 122.

In the print server 21 shown in FIG. 2B, the print job from the terminal apparatus 11 is received, and temporarily stored in the RAM 215 or the like, and then the CPU 211 analyzes the distribution destination identification information of the print job. The CPU 211 analyzes the distribution destination identification information so as to obtain a user name, a password, another user's name, and the fact that the other user's folder is designated as the storage destination of the print job. The CPU 211 searches for the folder in which the other user's name is registered, and stores the print job in the other user's folder that has been searched for in the external memory 214. For example, if the other user's folder is the folder 61-2, the print job is stored in the folder 61-2 in the external memory 214. Thus, in the present embodiment, a storage unit in the present invention is realized by the CPU 211 and the external memory 214.

Then, the CPU 211 reads an e-mail address from the folder 61-2 of the other user, and using this e-mail address, creates an e-mail addressed to the other user including a message indicating that the print job is stored in his or her folder 61-2, and transmits this e-mail from the communication I/F 222 to the network N. This e-mail is transmitted to the terminal apparatus 11 of the other user via the server on the network N. Accordingly, the other user can open and read this e-mail and can be informed that the print job is stored in his or her folder 61-2. Note that a configuration may be adopted in which a message from the transmission source user is transmitted from the terminal apparatus 11 to the print server 21, and this message is included in the e-mail. Thus, in the present embodiment, a mail transmission unit in the present invention is realized by the CPU 211 and the communication I/F 222.

The other user also goes to a desired multi-function peripheral 31, causes the card reader of the multi-function peripheral 31 to read authentication data of his or her own IC card for authentication of the authentication data, looks at a list of print jobs as shown in FIG. 7 described later in the folder 61-2 that have been transferred from the print server 21 to the multi-function peripheral 31, designates a print job in the folder 61-2, transfers this print job from the print server 21 to the multi-function peripheral 31, and executes this print job on the multi-function peripheral 31. Alternatively, the user may output a print job to an external portable memory (for example, a USB memory) via the external I/F 329 of the multi-function peripheral 31 so as to store the print job, and then remove this external portable memory so as to take it with him or her.

Furthermore, in the print server 21, the CPU 211 reads an e-mail address from the folder of the print job transmission source user after transferring the print job in the folder 61-2 of the other user. Using this e-mail address, the CPU 211 creates an e-mail that is addressed to the transmission source user and that includes a message indicating that the other user has received the print job, and transmits this e-mail to the network N. This e-mail is transmitted to the terminal apparatus 11 of the transmission source user via the server on the network N. The transmission source user opens and reads this e-mail, and is informed that the other user has received the print job.

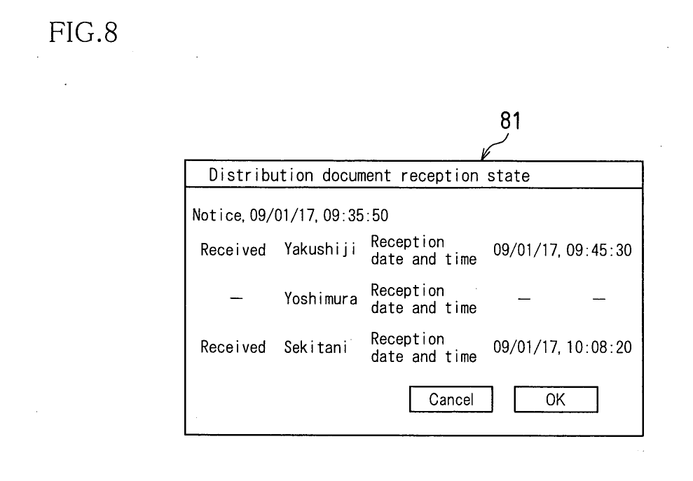

FIG. 8 illustrates an e-mail including a message indicating that other users have received a print job. This e-mail 81 includes “received”, user names selected as distribution destinations of the print job, and reception date and time.

In this way, distribution destination identification information set on the print distribution destination setting screen 51 of the terminal apparatus 11 is added to a print job, and this print job is transmitted to the print server 21. According to this distribution destination identification information, the print job is stored in the folder of the print job transmission source user, or the print job is stored in another user's folder. Accordingly, any user can go to a desired multi-function peripheral 31, transfer a print job in his or her folder from the print server 21 to that multi-function peripheral 31, and execute this print job.

Next, a description is given regarding a specific method for transferring a print job from the print server 21 to a multi-function peripheral 31.

In the multi-function peripheral 31 shown in FIG. 3, if an IC card is held over the card reader 316, authentication data of the IC card is read by the card reader 316, and the CPU 321 is notified of this authentication data via the external I/F 329. The CPU 321 transmits a request to verify this authentication data from the communication I/F 327 to the print server 21 via the network N.

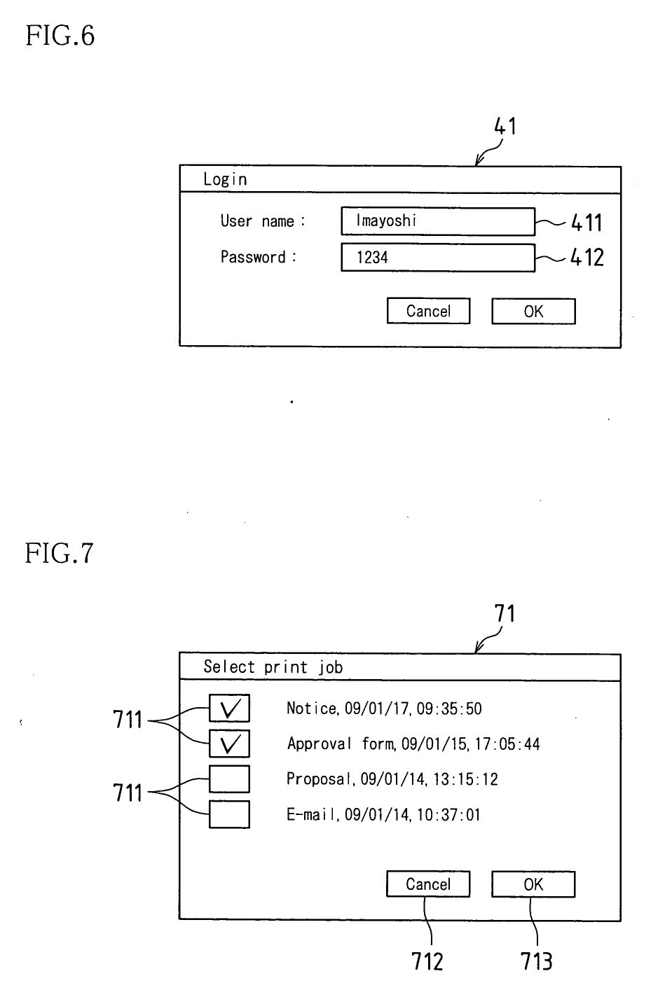

Note that a configuration may be adopted in which instead of the card reader 316 reading authentication data of an IC card, an authentication data input screen 41 as shown in FIG. 6 is displayed on the display device in response to an ID key operation on the screen of the display device of the operation input unit 315, and a user name and a password entered in fields 411 and 412 in the authentication data input screen 41 are inputted as authentication data. In this case, the user operates the buttons and keys displayed on the display device, so as to enter a name and a password.

In the print server 21 shown in FIG. 2B, a request to verify the authentication data from the multi-function peripheral 31 is received by the communication I/F 222, and the CPU 211 is notified of the request to verify the authentication data. The CPU 211 verifies this notified authentication data with pieces of authentication data in an authentication data table stored in advance in the external memory 214, and if this notified authentication data matches any authentication data in the authentication data table, an authentication reply for this notified authentication data is transmitted from the communication I/F 222 to the multi-function peripheral 31 via the network N.

In the multi-function peripheral 31 shown in FIG. 3, the authentication reply from the print server 21 is received by the communication I/F 327, and the CPU 321 is notified of this authentication reply. The CPU 321 determines that the authentication data of the IC card has been authenticated based on this authentication reply.

Subsequently, in the multi-function peripheral 31, on receiving the authentication reply from the print server 21, the CPU 321 is notified of this authentication reply. The CPU 321 transmits a transfer request for list data that indicates a list of print jobs in the folder belonging to the user of this authentication data from the communication I/F 327 to the print server 21 via the network N.

In the print server 21 shown in FIG. 2B, on receiving the transfer request for list data from the multi-function peripheral 31, the CPU 211 is notified of this transfer request. The CPU 211 searches for the folder belonging to the user of the authentication data based on this transfer request, generates list data that indicates a list of print jobs in this folder, and transmits this list data from the communication I/F 222 to the multi-function peripheral 31 via the network N.

In the multi-function peripheral 31 shown in FIG. 3, on receiving the list data from the print server 21, the CPU 321 gives an instruction to the operation I/F 326 to display the list of print jobs. Then, the operation I/F 326 displays the list of print jobs indicated by the list data received from the print server 21 on the screen of the display device attached to the operation input unit 315. Thus, in the present embodiment, a print job display unit in the present invention is realized by the CPU 321, the operation I/F 326, and the operation input unit 315.

FIG. 7 illustrates a list screen 71 for print jobs. On the list screen 71, respective check fields 711 for selecting a plurality of print jobs, the name and the creation date and time of each print job, a cancel button 712, and an OK button 713 are displayed. The user operates the buttons and keys displayed on the display device attached to the operation input unit 315 so as to check the check field 711 for the print job that he or she wishes to execute, and operates the OK button 713. Then, the operation I/F 326 notifies the CPU 321 of the name of the print job that corresponds to the check field 711 that has been checked, and the CPU 321 designates the print job that corresponds to the name of the print job notified by the operation I/F 326, and transmits a transfer request for this print job from the communication I/F 327 to the print server 21 via the network N. Thus, in the present embodiment, a print job selection unit in the present invention is realized by the operation input unit 315 and the operation I/F 326, and a transfer request unit is realized by the CPU 321 and the communication I/F 327.

In the print server 21 shown in FIG. 2B, on receiving the transfer request for the print job from the multi-function peripheral 31, the CPU 211 is notified of this transfer request. In response to this, the CPU 211 searches for the corresponding print job from the folder previously mentioned, and transfers this print job from the communication I/F 222 to the multi-function peripheral 31 via the network N. Thus, in the present embodiment, a transfer unit in the present invention is realized by the CPU 211 and the communication I/F 222.

On receiving the print job from the print server 21, the multi-function peripheral 31 shown in FIG. 3 temporarily stores this print job in the HDD 324 or the like, performs image processing on the image data of the print job in the image processing unit 336, and thereafter delivers this print job to the printer 313, and records an image (raster image) indicated by the image data of the print job on recording paper with the printer 313. At this time, instead of recording the image indicated by the image data of the print job, the print job may be outputted to an external portable memory (for example, a USB memory) via the external I/F 329, and stored therein. In this case, the print job can be loaded from the external memory to a desired terminal apparatus 11 by connecting the external portable memory to that terminal apparatus 11, which enables this print job to be displayed on the display screen of the terminal apparatus 11. Further, in the present embodiment, an external memory storage unit in the present invention is realized by the external I/F 329.

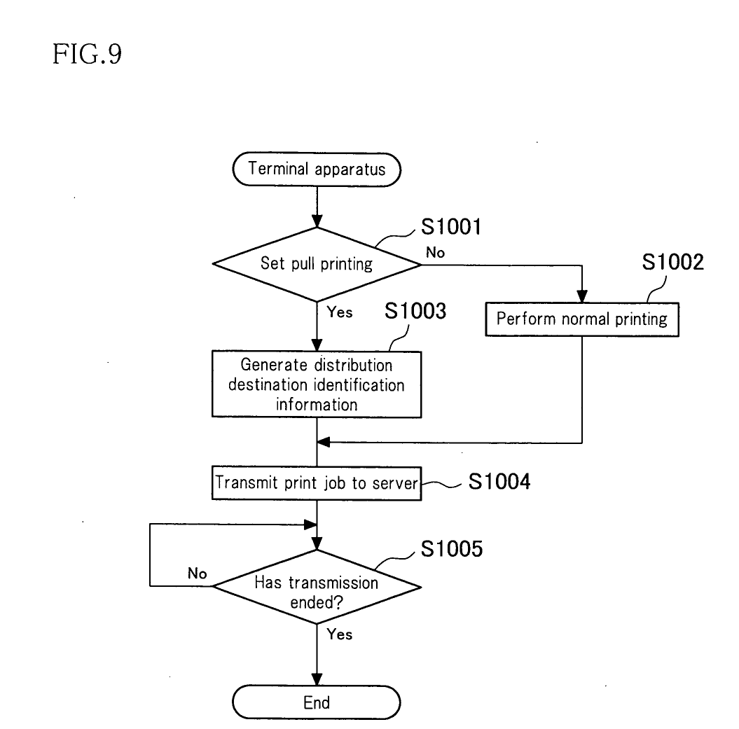

Next, processing procedures for transferring a print job from a terminal apparatus 11 to a multi-function peripheral 31 via the print server 21, and executing the print job will described in an organized manner, with reference to the flowcharts shown in FIGS. 9, 10, and 11.

FIG. 9 is a flowchart that shows a processing procedure performed by the terminal apparatus 11. With the terminal apparatus 11, first, the user operates the operation input unit 117 so as to select whether or not to perform pull printing, and set the selection (step S1001).

If it is not selected to perform pull printing (“No” in step S1001), a print job is transmitted from the terminal apparatus 11 to the print server 21 (steps S1002, S1004). When transmission of this print job ends (“Yes” in step S1005), the processing in FIG. 9 ends.

If it is selected to perform pull printing (“Yes” in step S1001), a print job is generated, distribution destination identification information is generated based on the entered contents on the print distribution destination setting screen 51, and then this distribution destination identification information is added to the print job (step S1003). Thereafter, this print job is transmitted from the terminal apparatus 11 to the print server 21 (step S1004). When transmission of this print job ends (“Yes” in step S1005), the processing in FIG. 9 ends.

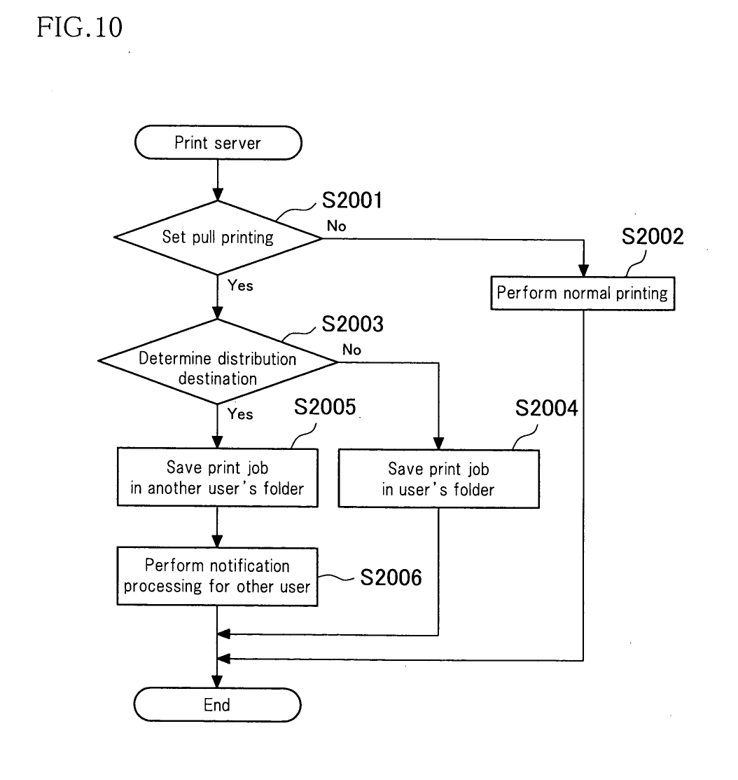

FIG. 10 is a flowchart that shows a processing procedure performed by the print server 21. On receiving the print job from the terminal apparatus 11, the print server 21 determines whether or not distribution destination identification information is added to the print job. If distribution destination identification information is not added, the print server 21 considers that not pull printing, but normal printing is to be performed thereon (“No” in step S2001), and immediately transfers this print job to the predetermined multi-function peripheral 31 (step S2002). The multi-function peripheral 31 receives and executes this print job. Accordingly, normal printing is performed.

If distribution destination identification information is added to the print job, it is considered that pull printing is to be performed thereon (“Yes” in step S2003). The distribution destination identification information of the print job is analyzed, and it is determined that either the user's own folder or another user's folder is designated as the storage destination of the print job (step S2003). If the user's own folder is designated (“No” in step S2003), the print job is stored in the user's own folder (step S2004).

Further, if the other user's folder is designated (“Yes” in step S2003), the print job is stored in the other user's folder (step S2005). Then, an e-mail address is read from the other user's folder, and an e-mail addressed to the other user including a message indicating that the print job is stored in his or her folder is created, and this created e-mail is transmitted to the network N (step S2006). This e-mail is transmitted to the other user's terminal apparatus 11 via the server on the network N, so as to notify the other user that the print job is stored in his or her folder.

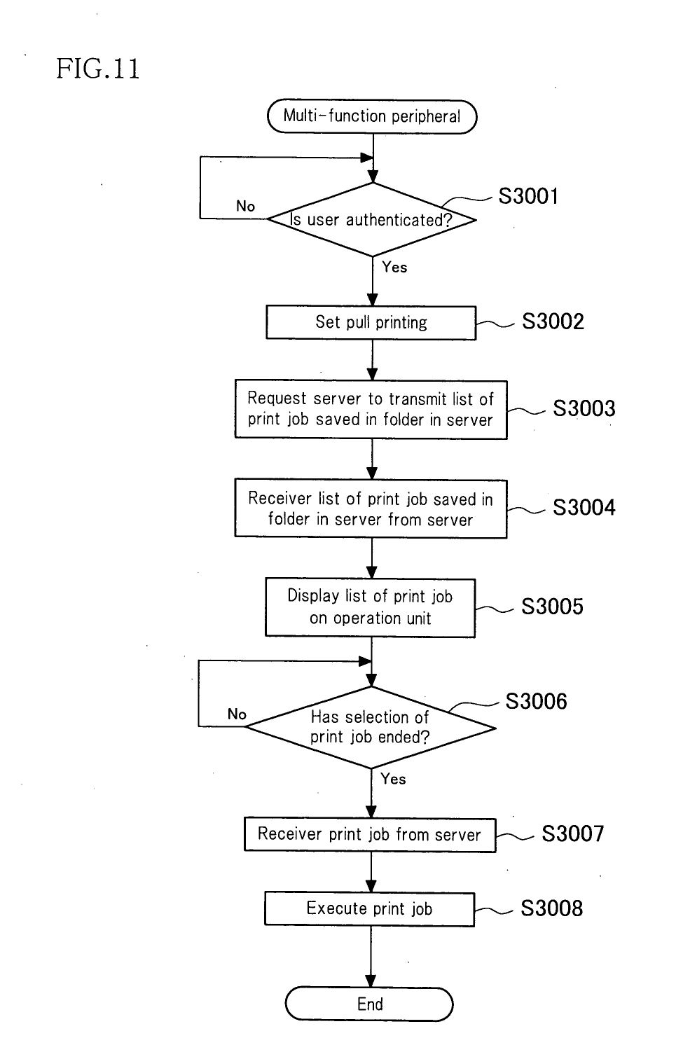

FIG. 11 is a flowchart that shows a processing procedure for pull printing performed by the multi-function peripheral 31. In the multi-function peripheral 31, authentication data of an IC card is read out, and a request to verify this authentication data is transmitted to the print server 21. If an authentication reply from the print server 21 is received (“Yes” in step S3001), pull printing is set (step S3002), and a transfer request for list data that indicates a list of print jobs in the folder belonging to the user of this authentication data is transmitted to the print server 21 (step S3003).

Then, on receiving list data from the print server 21 (step S3004), the list of print jobs indicated by this list data is displayed on the display device of the operation input unit 315 (step S3005).

The user operates the buttons and keys displayed on the display device, and selects the print job that he or she wishes to execute from the list.

When selection of this print job ends (“Yes” in step S3006), a transfer request for this selected print job is transmitted to the print server 21. Then, on receiving the print job from the print server 21 (step S3007), this print job is executed, and an image indicated by image data of the print job is recorded on recording paper (step S3008).

Thus, in the present embodiment, a configuration is possible in which a user's print job is transferred from the terminal apparatus 11 to another user's folder set in the print server 21, and stored therein. Accordingly, the other user can, by designating the print job in his or her folder in the print server 21 from a desired multi-function peripheral 31, transfer this print job from the print server 21 to that multi-function peripheral 31, and execute this print job on the multi-function peripheral 31.

Further, a plurality of other users are displayed on the terminal apparatus 11 side, an operation to select any of the displayed other users is performed on the terminal apparatus 11 side, and the user's print job is transferred to the folder of the selected other user. Accordingly, even if the folders of a plurality of other users are set in the print server 21, another desired user can be easily selected, and a print job can be transferred to the other user's folder, thereby improving operability.

Furthermore, if the print server 21 stores the user's print job in another user's folder, the print server 21 creates an e-mail addressed to the other user in order to notify him or her that the print job is stored, and transmits the e-mail thereto. Accordingly, the other user can check that e-mail on his or her terminal apparatus 11, and can be informed that the print job has been transmitted.

Further, the list of print jobs in the other user's folder set in the print server 21 is displayed on the multi-function peripheral 31 side, and an operation to select a print job from this displayed list is performed, so that this selected print job is transferred from the other user's folder to the multi-function peripheral 31. Accordingly, the other user can select a desired print job from his or her folder, transfer the print job to the multi-function peripheral 31, and execute the desired print job, thereby improving operability.

Furthermore, the multi-function peripheral 31 can store the print job transferred from the other user's folder set in the print server 21 in an external portable memory that is removably connected to that multi-function peripheral 31. Accordingly, the other user can store the print job in the external portable memory, instead of immediately executing the print job on the multi-function peripheral 31.

Note that in the present embodiment, although a print job is stored in a user's folder in the print server 21, instead of this, a configuration may be adopted in which when a print job from the terminal apparatus 11 is received by the print server 21, this print job is stored in a shared folder or the like on the print server 21 side, at least one user name serving as a destination is extracted from distribution destination identification information of this print job, and management data in which correspondence between the print job and the user name is established is generated. When performing pull printing, on receiving a user name and a password from the multi-function peripheral 31, the print server 21 searches for a print job corresponding to this user name from a management table, reads out this print job from the shared folder, and transmits this print job to the multi-function peripheral 31. In this case, even when the print job is delivered to a plurality of users, it is not necessary to store the print job in each user's folder one by one, and the print job may be stored only in the shared folder.

The present invention may be embodied in various other forms without departing from the gist or essential characteristics thereof. Therefore, the embodiments disclosed in this application are to be considered in all respects as illustrative and not limiting. The scope of the invention is indicated by the appended claims rather than by the foregoing description. All variations and modifications falling within the equivalency range of the appended claims are intended to be embraced therein.

What is claimed is:

1. A print system in which a terminal apparatus, a print server, and a printing apparatus are connected to each other via a network,
the terminal apparatus including:
a transmission unit for transmitting a print job of a user to the print server as a print job addressed to another user,
the print server including:
a storage unit for storing the print job of the user that has been transmitted from the terminal apparatus, as a print job addressed to the other user; and
a transfer unit for transferring the print job addressed to the other user stored by the storage unit to the printing apparatus in response to a request from the printing apparatus, and
the printing apparatus including:
a transfer request unit for requesting the print server to transfer the print job addressed to the other user, by designating the print job addressed to the other user stored in the print server.

2. The print system according to claim 1, wherein
the storage unit stores, in a folder of the other user, the print job addressed to the other user that has been transmitted from the terminal apparatus, and
the transfer unit transfers the print job stored in the folder of the other user to the printing apparatus.

3. The print system according to claim 2, wherein
the terminal apparatus includes:
a folder display unit for displaying folders of a plurality of other users set in the print server; and
a folder selection unit operated in order to select any of the folders of the other users displayed by the folder display unit, and
the storage unit stores the print job of the user in the folder of another user selected by the folder selection unit being operated.

4. The print system according to claim 1,
wherein the print server includes an e-mail transmission unit for, when the print job of the user is stored by the storage unit as a print job addressed to another user, creating and transmitting an e-mail addressed to the other user notifying that the print job is stored.

5. The print system according to claim 2,
wherein the print server includes an e-mail transmission unit for, when the print job of the user is stored by the storage unit as a print job addressed to another user, creating and transmitting an e-mail addressed to the other user notifying that the print job is stored.

6. The print system according to claim 3,
wherein the print server includes an e-mail transmission unit for, when the print job of the user is stored by the storage unit as a print job addressed to another user, creating and transmitting an e-mail addressed to the other user notifying that the print job is stored.

7. The print system according to claim 1, wherein
the printing apparatus includes:
a print job display unit for displaying a print job stored in the print server; and
a print job selection unit operated in order to select a print job displayed by the print job display unit, and
the transfer request unit requests the print server to transfer the print job selected by the print job selection unit being operated.

8. The print system according to claim 2, wherein
the printing apparatus includes:
a print job display unit for displaying a print job stored in the print server; and
a print job selection unit operated in order to select a print job displayed by the print job display unit, and
the transfer request unit requests the print server to transfer the print job selected by the print job selection unit being operated.

9. The print system according to claim 3, wherein
the printing apparatus includes:
a print job display unit for displaying a print job stored in the print server; and
a print job selection unit operated in order to select a print job displayed by the print job display unit, and
the transfer request unit requests the print server to transfer the print job selected by the print job selection unit being operated.

10. The print system according to claim 4, wherein
the printing apparatus includes:
a print job display unit for displaying a print job stored in the print server; and
a print job selection unit operated in order to select a print job displayed by the print job display unit, and
the transfer request unit requests the print server to transfer the print job selected by the print job selection unit being operated.

11. The print system according to claim 5, wherein
the printing apparatus includes:
a print job display unit for displaying a print job stored in the print server; and
a print job selection unit operated in order to select a print job displayed by the print job display unit, and
the transfer request unit requests the print server to transfer the print job selected by the print job selection unit being operated.

12. The print system according to claim 6, wherein
the printing apparatus includes:
a print job display unit for displaying a print job stored in the print server; and
a print job selection unit operated in order to select a print job displayed by the print job display unit, and
the transfer request unit requests the print server to transfer the print job selected by the print job selection unit being operated.

13. The print system according to any one of claims 1 to 12,
wherein the printing apparatus includes an external memory storage unit for storing the print job transferred from the print server in an external portable memory that is removably connected to the printing apparatus.
